(19) United States
(12) Patent Application Publication
(10) Pub. No.: US 2017/0090582 A1
(43) Pub. Date: Mar. 30, 2017

(54) FACILITATING DYNAMIC AND INTELLIGENT GEOGRAPHICAL INTERPRETATION OF HUMAN EXPRESSIONS AND GESTURES

(71) Applicant: INTEL CORPORATION, SANTA CLARA, CA (US)

(72) Inventors: KRISHNA KUMA GANESAN, PORTLAND, OR (US); NICHOLAS J. ADAMS, HILLSBORO, OR (US); ROBERT E. GOUGH, SHERWOOD, OR (US)

(73) Assignee: INTEL CORPORATION, SANTA CLARA, CA (US)

(21) Appl. No.: 14/864,778

(22) Filed: Sep. 24, 2015

(51) Int. Cl. G06F 3/01; G06F 3/16; H04L 12/58; G06F 17/24; G06F 3/0484; H04L 29/08; G06T 13/80; G06F 17/28

(52) U.S. Cl. CPC G06F 3/017; G06T 13/80; G06F 3/16; G06F 17/2809; G06F 17/245; G06F 3/0484; H04L 67/306; H04L 67/18; H04L 51/046

(57) ABSTRACT

A mechanism is described for facilitating dynamic and intelligent geographical interpretation of human expressions and gestures according to one embodiment. A method of embodiments, as described herein, includes detecting a gesture initiated by a sending user having access to a computing device, determining a geographic location of the computing device, and accessing a translation table having one or more translations of one or more gestures based on one or more geographic locations, where accessing further includes choosing a translation corresponding to the gesture. The method may further include interpreting a first intent associated with the gesture based on the translation, and triggering a first action based on the first intent.

### FIELD

Embodiments described herein generally relate to computers. More particularly, embodiments relate to facilitating dynamic and intelligent geographical interpretation of human expressions and gestures.

### BACKGROUND

People are diverse in nature and so are their expressions. Several studies have shown that human expressions are very much tied to culture and thus one expression can be interpreted one way in one geographic location, but another way in another geographic location. Conventional techniques lack intelligence and are not cognizant enough of the local culture to be able to interpret the real intent behind various gestures, expressions, and other such actions.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a geographical gesture/expression interpretation mechanism according to one embodiment.

FIG. 2 illustrates a geographical gesture/expression interpretation mechanism according to one embodiment.

FIG. 3 illustrates a use case scenario for interpreting gestures according to one embodiment.

FIG. 4 illustrates a method for interpreting gestures/expressions according to one embodiment.

FIG. 5 illustrates computer environment suitable for implementing embodiments of the present disclosure according to one embodiment.

FIG. 6 illustrates a method for facilitating dynamic targeting of users and communicating of message according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel technique for intelligently and dynamically interpreting various human expressions and gestures, which may then be used by software and/or hardware at a computing device to take an appropriate and relevant action.

Since by and large cultural expressions and gestures can be tied to and profiled by geographical locations, embodiments provide for a novel technique for capturing geographical identification metadata as primary cue for interpreting human gestures and expressions. It is contemplated that other necessary as well as optional secondary cues (e.g., name, accent, pronunciation, etc.) may be used along with the primary cue to better and more accurately interpret human gestures and expressions. In one embodiment, any metadata may be used to parse through the gestures/expressions to be able to interpret the meaning of a particular gestures/expression before an appropriate action can be taken. For example, in some embodiments, a database may contain and maintain appropriate translations for any number and type of gestures, expressions, etc., for each geo-fenced location. This allows for correct processing of gestures/expressions in accordance with their geographical locations as well as any other necessary secondary cues by a computing device.

It is completed that with growing use and popularity of mobile and wearable computing devices, embodiments may provide for the necessary intelligence to allow for culturally proper interpretation of human gestures and expressions to bring together peoples of various cultures by promoting cultural understanding.

It is contemplated and to be noted that embodiments are not limited to any particular number and type of software applications, application services, customized settings, etc., or any particular number and type of computing devices, networks, deployment details, etc.; however, for the sake of brevity, clarity, and ease of understanding, throughout this document, references are made to user expressions, gestures, profiles, primary and secondary cues or characteristics, software applications, user preferences, customized settings, mobile computers (e.g., smartphones, tablet computers, etc.), communication medium/network (e.g., cloud network, the Internet, proximity network, Bluetooth, etc.), but that embodiments are not limited as such.

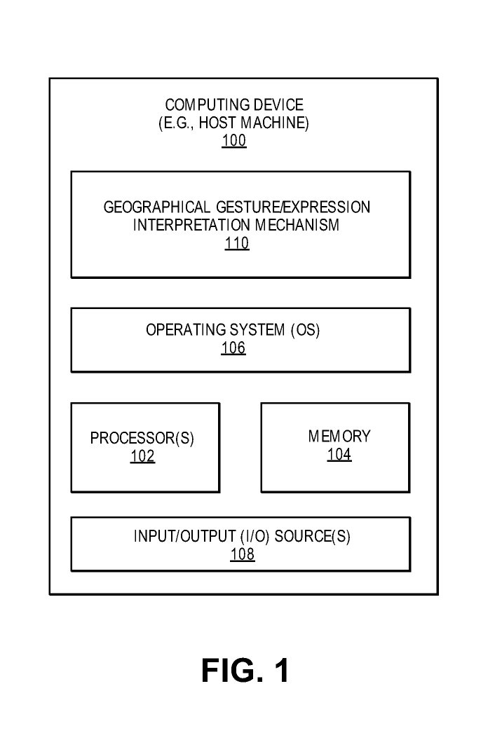

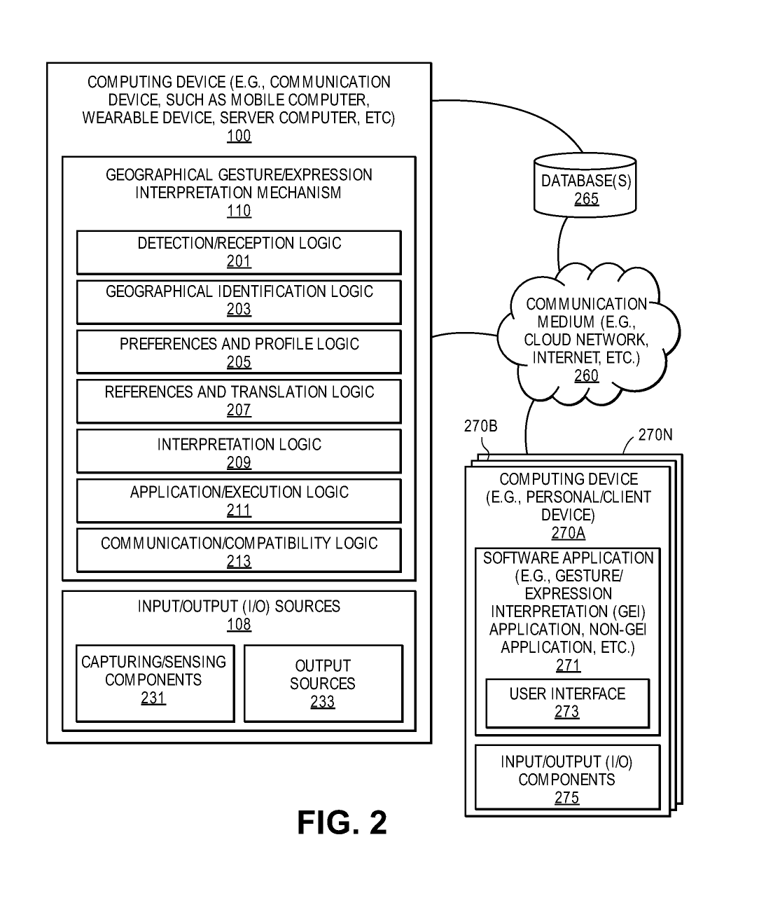

FIG. 1 illustrates a computing device 100 employing a geographical gesture/expression interpretation mechanism 110 according to one embodiment. Computing device 100 serves as a host machine for hosting intelligent gesture/expression interpretation mechanism (“geo-interpretation mechanism”) 110 that includes any number and type of components, as illustrated in FIG. 2, to facilitate dynamic and real-time interpretation of human gestures and expressions that may have different meaning in different cultures and geographic locations, as will be further described throughout this document.

Computing device 100 may include any number and type of data processing devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, head-mounted displays (HMDs) (e.g., wearable glasses, such as Google® Glass™, head-mounted binoculars, gaming displays, military headwear, etc.), and other wearable devices (e.g., smartwatches, bracelets, smartcards, jewelry, clothing items, etc.), and/or the like.

Computing device 100 may include an operating system (OS) 106 serving as an interface between hardware and/or physical resources of the computer device 100 and a user. Computing device 100 further includes one or more processor(s) 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a group of individuals using or having access to computing device 100.

FIG. 2 illustrates a geographical gesture/expression interpretation mechanism 110 according to one embodiment. In one embodiment, geo-interpretation mechanism 110 may include any number and type of components, such as (without limitation): detection/reception logic 201; geographical identification logic 203; preferences and profile logic 205; reference and translation logic 207; interpretation logic 209; application/execution logic 211; and communication/compatibility logic 213.

In one embodiment, geo-interpretation mechanism 110 may be hosted by computing device 100, such as a communication device including a mobile computer (e.g., smartphone, tablet computer, etc.), wearable computer (e.g., wearable glasses, smart bracelets, smartcards, smart watches, HMDs, etc.), and/or the like. In another embodiment, computing device 100 may be a larger communication machine, such as a server computer, a desktop computer, a laptop computer, etc., that is in communication with one or more smaller computing devices 270A, 270B, 270N (e.g., mobile computer, such as a smartphone, a tablet computer, etc.) over communication medium 260, such as one or more networks (e.g., Cloud network, the Internet, proximity network, such as Bluetooth, etc.).

For example and in one embodiment, computing device 100 may serve as a server computer hosting geo-interpretation mechanism 110 in its entirety while communicating one or more services offered by geo-interpretation mechanism 110 with one or more personal devices, such as computing devices 270A-N, over communication medium 260, such as a cloud network. In another embodiment, computing device 100 may be another personal device, such as similar to or the same as one of computing devices 270A-N, where each computing device 100, 270A-N may include geo-interpretation mechanism 110, either partially or entirely, as part or in support of software application (“application” or “client-based application”) 271 which may include a gesture/expression interpretation (GEI) application or any other form of software application that is not a GEI-based application. For example, in case of a non-GEI application, a user having access to personal device 270A may use personal device 270A for any number and type of basic services and functionalities, such as capturing a facial expression through a camera of personal device 270A, etc., but rely on another source, such as computing device 100 serving as a server computer and hosting geo-interpretation mechanism 110, for assistance in interpreting the facial expression captured at personal device 270A.

For example and in one embodiment, application 271 may be a client-based GEI-based application that is downloadable over communication medium 260 (e.g., cloud network, the Internet, proximity network, etc.) such that gesture/expression interpretation-specific features may be implemented, supported, and offered through application 271 and accessible via user interface 273 (e.g., mobile application interface, web browser, etc.). Further, for example and in another embodiment, application 271 may not be a GEI-implemented application, but may still be capable of supporting certain basic services, such as collection, gathering, capturing, etc., of gestures, expressions, etc., that are then communicated with computing device 100 to then provide additional and full services via geo-interpretation mechanism 110, such as interpretation of those gestures and expressions captured at personal device 270A hosting application 271.

Computing device 100 may include I/O source(s) 108 including capturing/sensing components 231 and output components 233 which, as will be further described below, may also include any number and type of components, sensor arrays, detectors, displays, etc. For example, capturing/sensing components 231 may include (without limitation) two-dimensional (2D) cameras, three-dimensional (3D) cameras, sensor arrays, microphones, etc., while, output components 233 may include (without limitation) display screens, display/projection areas, projectors, speakers, etc.

Computing devices 100, 270A-N may be further in communication with one or more repositories or data sources or databases, such as database(s) 265, to obtain, communicate, store, and maintain any amount and type of data (e.g., gesture/expression data, cultural/geographical relevancy data, preferences and profiles of users, geographic locations, other location-related information, media, metadata, templates, real-time data, historical contents, user and/or device identification tags and other information, resources, policies, criteria, rules, regulations, upgrades, etc.).

In some embodiments, communication medium 260 may include any number and type of communication channels or networks, such as cloud network, the Internet, intranet, Internet of Things (“IoT”), proximity network, such as Bluetooth, etc. It is contemplated that embodiments are not limited to any particular number or type of computing devices, services or resources, databases, networks, etc.

As with computing device 100, each of computing devices 270A-N may include I/O components 275, such as (without limitation) sensors, detectors, actuators, microphones, speakers, 2D/3D cameras, touchscreens, and/or the like. For example, computing device 100 may include I/O sources 108 having any number and type of capturing/sensing components 231 (e.g., sensor array (such as context/context-aware sensors and environmental sensors, such as camera sensors, ambient light sensors, Red Green Blue (RGB) sensors, movement sensors, etc.), depth sensing cameras, 2D cameras, 3D cameras, image sources, audio/video/signal detectors, microphones, eye/gaze-tracking systems, head-tracking systems, etc.) and output components 233 (e.g., audio/video/signal sources, display planes, display panels, display screens/devices, projectors, display/projection areas, speakers, etc.).

Capturing/sensing components 231 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing components 231 may further include one or more of supporting or supplemental devices for capturing and/or sensing of data, such as illuminators (e.g., infrared (IR) illuminator), light fixtures, generators, sound blockers, etc.

It is further contemplated that in one embodiment, capturing/sensing components 231 may further include any number and type of context sensors (e.g., linear accelerometer) for sensing or detecting any number and type of contexts (e.g., estimating horizon, linear acceleration, etc., relating to a mobile computing device, etc.). For example, capturing/sensing components 231 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); gravity gradiometers to study and measure variations in gravitation acceleration due to gravity, etc.

Further, for example, capturing/sensing components 231 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.), biometric sensors (such as to detect fingerprints, etc.), calendar maintenance and reading device), etc.; global positioning system (GPS) sensors; resource requestor; and trusted execution environment (TEE) logic. TEE logic may be employed separately or be part of resource requestor and/or an I/O subsystem, etc. Capturing/sensing components 231 may further include voice recognition devices, photo recognition devices, facial and other body recognition components, voice-to-text conversion components, etc.

Computing device 100 may further include one or more output components 233 in communication with one or more capturing/sensing components 231 and one or more components of geo-interpretation mechanism 110. Similarly, output components 233 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output components 233 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

As previously described, gestures (e.g., hand gestures, such as a victory sign, thumbs up or down, etc.) and expressions (e.g., facial expressions, such as smile, frown, closed or open eyes, twitching of the nose, etc.) may be interpreted using a number of different inputs beyond merely the action (such as gesture or expression) itself. In one embodiment, to generate an accurate rendition of gestures and/or expressions, geographic location serves as the primary cue, implying their cultural context. For example, a geo-fencing technique may be used to allow for a geo-fence around an area, such as a country, to then be used for interpreting a gesture/expression in accordance with its cultural translation within the geo-fenced area so that a proper and appropriate action may be taken in response. Then, as new gestures/expressions are used in other geographical locations, they can then be tagged in a translator token warehouse.

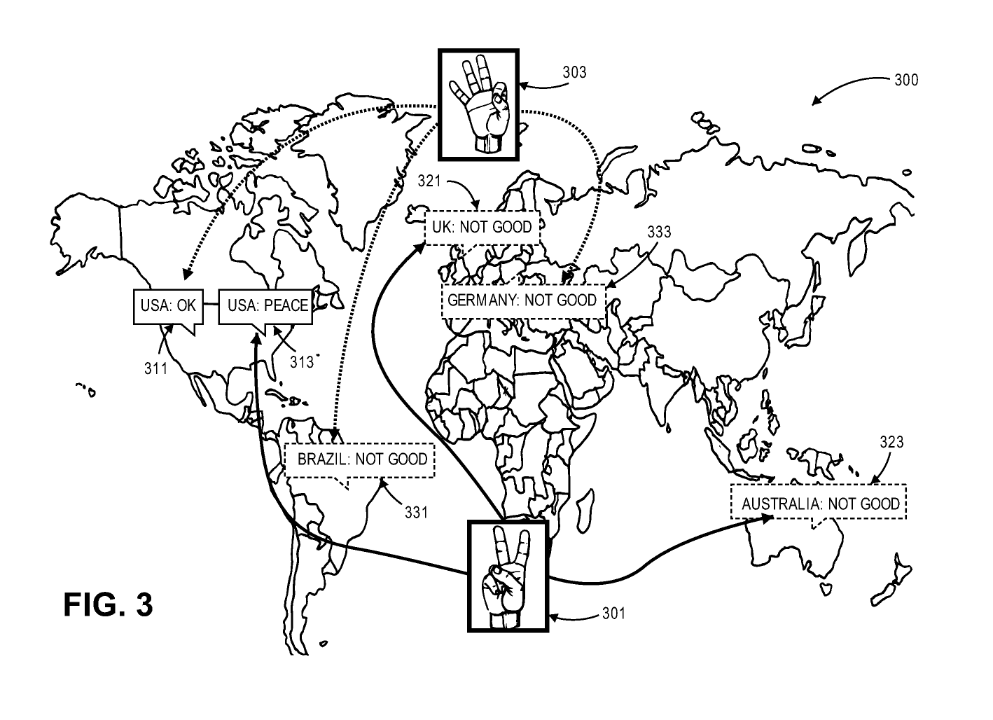

Referring back to geo-interpretation mechanism 110, for example and in one embodiment, a gesture or expression may be detected via one or more of capturing/sending components 231, such as a camera, a sensor, etc., such as a user forming a sign with the index and middle fingers of the user's hand, such as “V-sign” or “v-gesture”, as shown with respect to FIG. 3. It is contemplated that this V-sign qualifies as a dynamic gesture that may be interpreted differently in various cultures and/or parts of the world, such as in various Middle Eastern countries, this gesture may be regarded as a “victory” sign, while in the United States of America (“USA” or simply “US”), it may be interpreted as a “peace” sign or a even form of “informal greeting”, such as a hello and/or a bye, and yet in many other parts of the world (such as in Australia, Brazil, etc.), the gesture may be regarded as bad or even offensive.

Similarly, any number of gestures, facial expressions, etc., may be interpreted differently in different parts of the world as varying emotional signs, commands, messages, etc., based on local cultures, traditions, perceptions, history, religions, peoples, etc. It is contemplated that embodiments are not limited to any particular number or type of gestures (e.g., hand gestures), expressions (e.g., facial expressions); nevertheless, for brevity, clarity, and ease of understanding, the aforementioned “V-sign” is discussed as an example throughout this document even though embodiments are not limited as such.

Upon detecting a gesture/expression, such as V-sign, in one embodiment, geographical identification logic 203 may be triggered to detect or identify a current geographic location of the sending device, such as computing device 100, and the receiving device, such as personal device 270A, to determine the corresponding locations of the sending user (“sender”) and the receiving user (“receiver”), respectively, to further determiner the correct interpretation of the gesture made by the sender to be communicated to the receiver.

For example, if a sender, in the US, having access to computing device 100 makes the aforementioned V-sign with the intention of saying “goodbye” to a receiver, in Australia, having access to personal device 270A, the gesture may be detected and identified by detection/reception logic 201 to then be further processed by various components of geo-interpretation mechanism 110. In one embodiment, upon detection of the gesture, geographical identification logic 203 may be triggered to detect current geographic locations of the two users, such as sender and receiver, by determining the current geographic locations of their two respective devices, such as computing device 100 and personal device 270A. It is contemplated that geographic locations may not be detected merely upon detection of a gesture. For example, in some embodiments, geographical identification logic 203 may be used continuously or triggered periodically (such as upon reaching predetermined periods of time (e.g., every 30 minutes, etc.), occurrence of events (e.g., movement of device over a predetermined period of distance, such as 100 miles), etc.), and/or the like.

It is contemplated that any number and type of geographic location detection, tracking, and/or surveillance (collectively referred to as “location-detection”) techniques, such as a GPS-based technique, may be employed at one or more devices, such as computing device 100 and/or personal device 270A or a third-party computer (e.g., cloud server, etc.), and used by geographical identification logic 203 and/or application 271, to determine the current locations. It is contemplated that embodiments are not limited to any particular location-detection technique and that any number and type of location-detection techniques may be employed and used for location-detection purposes. In one embodiment, upon determining the current geographic locations of the two computing devices 100, 207A, geographical identification logic 203 may forward this geographic information to reference and translation logic 207 for further processing.

It is contemplated that the two users, such as the sender/receiver, may communicate with each other using any number and type of communication applications, such as a video game, voice over Internet Protocol (VoIP), such as FaceTime®, Skype®, Viber®, etc., through communication/compatibility logic 213 and one or more other software applications, such as application 271. Further, for example, users may be in communication over IoT using one or more of drone gaming, 3D real sense cameras, immersive shopping, adding more eyes (e.g., cameras) to their computing devices, such as computing devices 100, 270A-N, for better natural human interaction, etc.

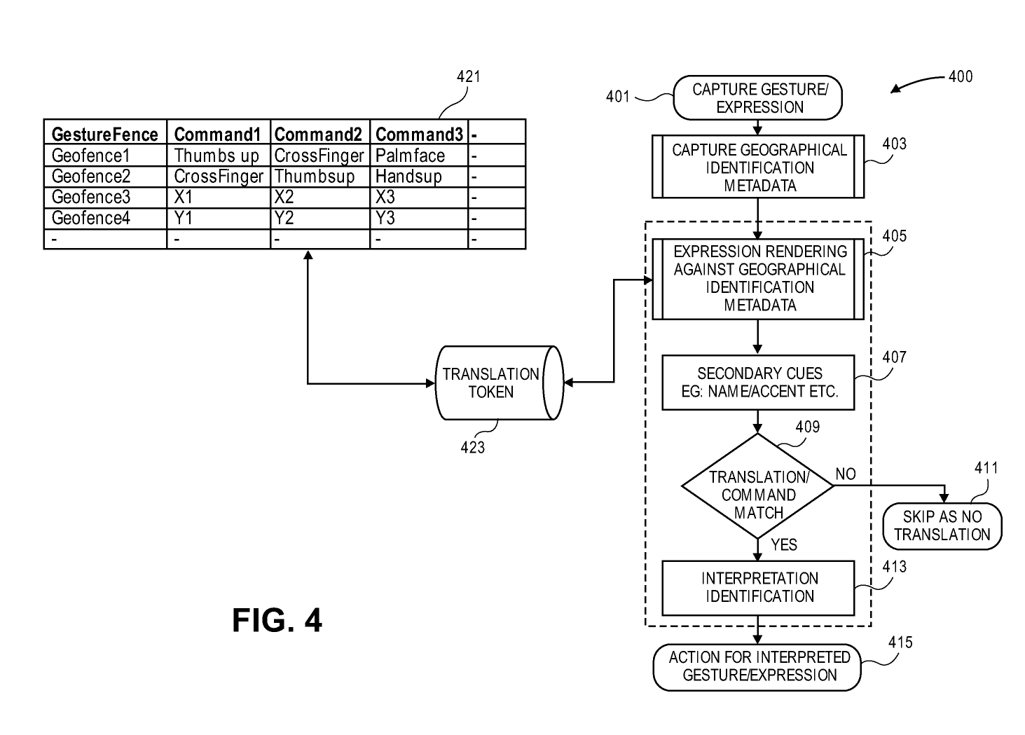

In one embodiment, upon receiving the geographic information/metadata, reference and translation logic 207 may refer to any existing data, such as a translation table based on geo-fencing, etc., stored at Database® 265, as illustrated in FIG. 4, to determine any possible interpretations or intentions relating to a gesture or expression, such as the V-sign. For example, the translation table may refer to or include an interpretation table that is predetermined and continuously updated with a list of any number and type of gestures, expressions, etc., and a corresponding list of the intents or interpretations of those gestures, expressions, etc., in accordance with each culture, tradition, physical location, historical background, etc. For example, such translation table may be generated and maintained based on specific geographic areas around the world as marked by geo-fencing, etc. For example, geographical identification logic 203 may be used for or along with a geo-fencing software application for using GPS or radio frequency identification (RFID) to define various geographical boundaries, where a geo-fence may refer to a virtual barrier.

Continuing with the V-sign example, upon referencing the translation table, reference and translation logic 207 may determine that the V-sign is not regarded as a good gesture in Australia and thus a proper intent of the V-sign as intended by the sender in the US ought to be determined and conveyed to the receiver in Australia, such as by converting the V-sign into another equivalent gesture (e.g., waving hand indicating a goodbye, etc.), annotating the V-sign with a textual and/or animated note (e.g., animated waving hand, text reciting “goodbye!”), etc., to clarify the sender's proper intent to the receiver. In another embodiment, the particular gesture, such as the V-sign, may be completely blocked from being communicated to the receiver. In yet another embodiment, the gesture, such as the V-sign, may be allowed to go through for any number and type of reasons, such as when no translation for the gesture is found in the translation table or elsewhere (such as upon searching the Web, other databases, etc.) or the gesture is allowed to be communicated based on user preferences and profiles.

In one embodiment, preferences and profile logic 205 may be triggered to refer to one or more user profiles and/or user preferences relating to one or more of senders and/or receivers to further determine whether the sender's gesture needs to be handled in a particular manner. For example and in one embodiment, any number and type of factors may be identified in a user preference and/or profile not only to indicate the intent of the sender's gesture/expression, but also its relevance to the expected receiver. For example, the sender may have indicated as user/sender preference not to his gestures and/or expressions when communicating with friends, family, teammates, classmates, etc., but to strictly interpret when communicating with work colleagues, business partners, professors/teachers, strangers, etc. For example, being friends, both the sender and the receiver may know each other's gestures, expressions, etc., leaving no reason for their interpretation.

Similarly, for example, a user profile, as provided by preferences and profile logic 205, may indicate other secondary cues or details about one or more users to help reference and translation logic 207 further determine how a particular gesture and/or expression may be handled. Continuing with V-sign, if, for example, user/receiver profile indicates that the receiver, although in Australia, is from or has previously lived in the US, then reference and translation logic 207 may choose not to translate the V-sign since, in this case, the receiver is expected to be familiar with the US culture and know the intent or meaning of the sender's V-sign.

Further, any number and type of user-related and/or user-inputted data may be obtained and offered through user profiles and/or preferences as secondary cue to work with the primary cute of geographical location-related metadata to more accurately determine the true intent of gestures/expressions, where such data may include (without limitations): user's citizenship, residency, country of birth, race, ethnicity, religion, name, mother tongue, language skills, accent, and/or the like.

It is contemplated that certain qualifiers or conditions may be associated with such determinations, such as simply vising the US once for a short period of time as a tourist may not be sufficient enough to qualify the receiver as knowing the US culture, etc. Similarly, in some embodiments, certain sender and/or receiver preferences may depend on various user modes or mode-related settings, such as work mode, play mode, family mode, etc., where certain gestures and/or expression may be interpreted according to a current user mode and the corresponding preferences.

It is contemplated and as previously discussed, by and large gestures and/or expressions can be profiled by geographical locations and their respective cultures, traditions, etc., and thus, in one embodiment, as facilitated by geographical identification logic 203, any geographical identification metadata relating to a gesture/expression may be captured and used as primary cue, while, as facilitated by preferences and profile logic 205, any user-related data, such provided or inputted through user profiles and/or preferences, may be used as secondary cue to interpret and disclose the intent of one or more user gestures and/or expressions. In one embodiment, this data being used as the primary and secondary cues may then be parsed by reference and translation logic 207 for intermediate translation and, in one embodiment, matched against contents of a translation table that is queried and accessed via one or more databases, such as database(s) 265, prior to taking any action corresponding to the gesture/expression. This novel technique allows for taking of a correct and appropriate action in response to the gesture/expression in accordance with its true intent as aspired by the sender of the gesture/expression.

In one embodiment, this intermediate translation is provided by reference and translation logic 207 to interpretation logic 209 to then interpret the real intent of the given gesture/expression, such as the V-sign. Stated differently, once the relevant data is obtained and evaluated, interpretation logic 209 may then decipher the actual intent of the gesture/expression as intended or aspired by the sender. Continuing with the V-sign example, interpretation logic 209, using the intermediate translation, may determine the sender's real intent as wishing the receiver a “goodbye”. In one embodiment, once the intent is determined by interpretation logic 209, application/execution logic 211 is triggered to perform one or more acts corresponding to the determined intent of the gesture/expression. Again, continuing with the V-sign example, if the intent is determined to be a “goodbye”, application/execution logic 211 may apply and execute a relevant action, such as display a waving hand, recite or play appropriate text or animation, such as the words “goodbye!”, allow the gesture of V-sign to get through to the receiver, as-is, based on one or more of user preferences, profiles, etc., such as upon determining that the receiver is familiar with the sender's gesture, culture, tradition, and/or the like, and thus capable of knowing or deciphering the sender's real intent behind the gesture.

Communication/compatibility logic 213 may be used to facilitate dynamic communication and compatibility between computing devices 100, 270A-N, database(s) 265, communication medium 260, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, the Internet, Internet of Things, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and the like, may be referenced interchangeably and include, by way of example, software, hardware, and/or any combination of software and hardware, such as firmware. In an example, “logic” may refer to or include a software component that is capable of working with one or more of an operating system, a graphics driver, etc., of a computing device, such as computing devices 100, 270A-N. In another example, “logic” may refer to or include a hardware component that is capable of being physically installed along with or as part of one or more system parts, such as an application processor, a graphics processor, etc., of computing devices 100, 270A-N. In yet another embodiment, “logic” may refer to or include a firmware component that is capable of being part of system firmware, such as firmware of an application processor or a graphics processor, etc., of computing devices 100, 270A-N.

Further, any use of a particular brand, word, term, phrase, name, and/or acronym, such as “gesture”, “expression”, “facial expression”, “gesture/expression interpretation”, “GEI”, “GPS”, “IoT”, “user profile”, “user preference”, “user”, “sender”, “receiver”, “context”, “interpretation”, “intent”, “action”, “personal device”, “smart device”, “mobile computer”, “wearable device”, etc., should not be read to limit embodiments to software or devices that carry that label in products or in literature external to this document.

It is contemplated that any number and type of components may be added to and/or removed from geo-interpretation mechanism 110 to facilitate various embodiments including adding, removing, and/or enhancing certain features. For brevity, clarity, and ease of understanding of geo-interpretation mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3 illustrates a use case scenario 300 for interpreting gestures 301, 303 according to one embodiment. As an initial matter, for brevity, clarity, and ease of understanding, many of the components and processes discussed above with reference to FIGS. 1-2 may not be repeated or discussed hereafter. It is contemplated and to be noted that embodiments are not limited to any particular use case scenario, architectural setup, transaction sequence, gesture, facial expression, etc., and further, any number and type of components, such as geo-interpretation mechanism 110, may be employed, placed, and used in any manner, order, and/or form to perform the relevant tasks.

As discussed with respect to FIG. 2, a first gesture 301 (e.g., V-sign) may be acceptable in the US 313 as it may be regarded as a “peace” sign or an “informal greeting”; however, the same first gesture 301 may not be acceptable in the United Kingdom (UK) 321 and Australia 323. Similarly, second gesture 303 (e.g., index-thumb loop sign) may be regarded as an “okay” gesture in the US 311, but may not be acceptable in Brazil 331 or Germany 333.

As discussed with respect to FIG. 2, interpretations of gestures and/or expressions can vary significantly in different geographic parts of the world depending on one or more of the culture, tradition, perception, history, etc. Further, as described with reference to FIG. 2, gestures and expressions are interpreted using any number and type of different inputs beyond merely the action itself. This novel technique allows for an accurate interpretation and rendition of gestures and expressions that are based on geographical locations that insinuate cultural contexts. For example, using a geo-fence around a specific country as primary cue for interpreting first and second gestures 301, 303 and producing and executing accurately translated actions that reflect the true intent of the sender(s) of first and second gestures 301, 303. Further, as new gestures/expressions are used in other geographic locations, they can be tagged in a translator token warehouse at one or more databases, such as database(s) 265, and used for generating and updating a translation table to provide interpretation of various gestures/expression as they are used in different geographic regions around the world.

FIG. 4 illustrates a method 400 for interpreting gestures/expressions according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed by geo-interpretation mechanism 110 of FIGS. 1-3. The processes of method 400 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

Method 400 begins at block 401 with capturing of gestures and/or expressions. In one embodiment, at block 403, geographical identification metadata is detected and captured for using as primary cue for interpreting the gestures and/or expressions as described with reference to FIG. 2. At block 405, in one embodiment, expression rendering is performed against the captured geographical identification metadata using data obtained from translation table 421 (based on geo-fencing) as triggered by and communicated through translation token 423.

At block 407, in one embodiment, secondary cue, such as user names, accents, life history, job history, education level, marital status, etc., may be obtained from one or more of user preferences and/or profiles. Using the matching data from translation table 421, based on the primary cue of geographical identification metadata, along with the secondary cue of user profiles/preferences, etc., at block 409, a decision is made as to whether there is a match between a gesture/expression and a translation. If not, at block 411, in one embodiment, no translation is regarded as necessary and the gesture/expression is forwarded on to a receiving user without in its original form without any interpretation or explanation and an appropriate action is taken. If yes, at block 413, in one embodiment, a true interpretation of the gesture/expression is identified and accordingly, a proper intent of the sending user is detected. At block 415, in one embodiment, an appropriate action (e.g., displaying an equivalent but different gesture/expression, issuing a replacement or supplemental textual or audio explanation, etc.) is taken for the interpreted gesture/expression.

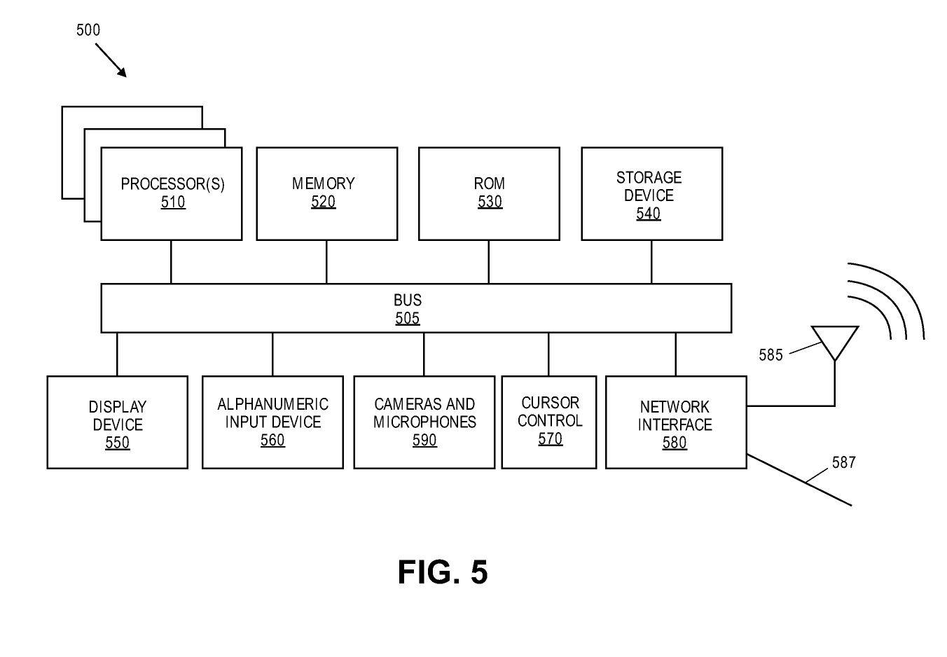

FIG. 5 illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

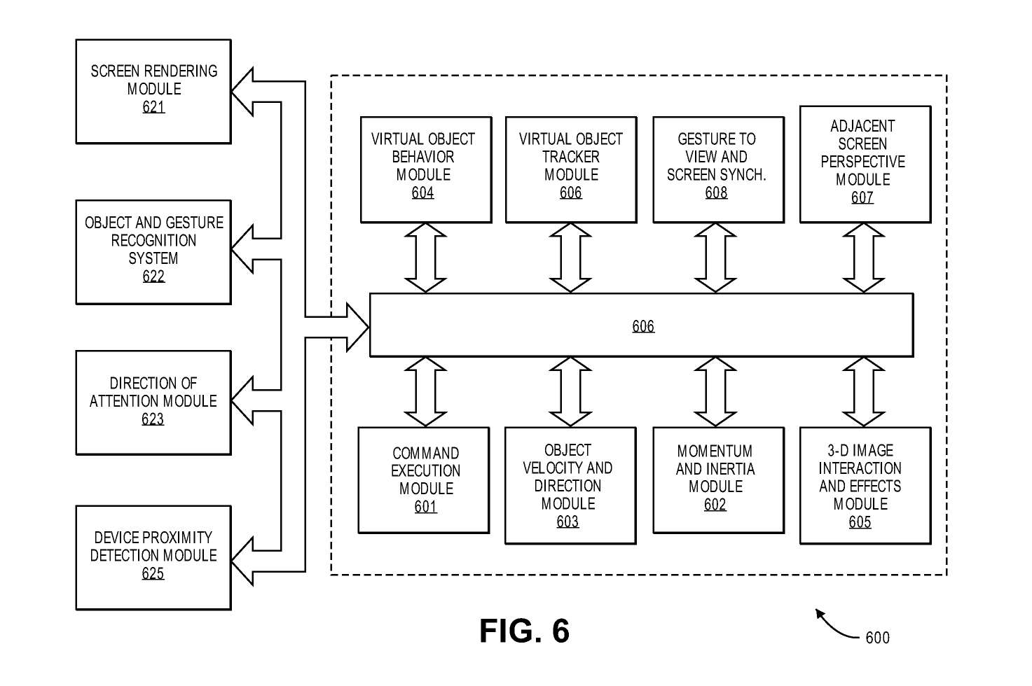

FIG. 6 illustrates an embodiment of a computing environment 600 capable of supporting the operations discussed above. The modules and systems can be implemented in a variety of different hardware architectures and form factors including that shown in FIG. 4.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers.

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate dynamic and intelligent geographical interpretation of human expressions and gestures, comprising: detection/reception logic to detect a gesture initiated by a sending user having access to the apparatus; geographical identification logic to determine a geographic location of the apparatus; reference and translation logic to access a translation table having one or more translations of one or more gestures based on one or more geographic locations, wherein the reference and translation logic is further to choose a translation corresponding to the gesture; interpretation logic to interpret a first intent associated with the gesture based on the translation; and application/execution logic to trigger a first action based on the first intent.

Example 2 includes the subject matter of Example 1, further comprising preferences and profile logic to collect user preferences relating to at least one of the sending user and the receiving user, wherein the user preferences include user-preferred criteria regarding at least one of translation of the gesture, interpretation of the gesture, and transmission of the gesture.

Example 3 includes the subject matter of Example 2, wherein the preferences and profile logic is further to generate at least one of a first user profile relating to the sending user and a second user profile relating to the receiving user, wherein the first and second user profiles are generated based on the user preferences.

Example 4 includes the subject matter of Example 2 or 3, wherein the first and second user profiles comprise identifying data relating to the first and second users, respectively, wherein the identifying data includes one or more of names, citizenships, nationalities, ethnicities, mother tongues, language skills, accents, physical appearances, and historical acts.

Example 5 includes the subject matter of Example 1, wherein the reference and translation logic is further to access the preferences and profile logic to obtain reference content from at least one of the user preferences, the first user profile, and the second user profile.

Example 6 includes the subject matter of Example 1 or 5, wherein the interpretation logic is further to interpret a second intent associated with the gesture based on the translation and the reference content, and wherein the application/execution logic is further to trigger a second action based on the second intent.

Example 7 includes the subject matter of Example 1, further comprising communication/compatibility logic to transmit a message based on at least one of the first action and the second action, wherein the message includes at least one of the gesture, an equivalent gesture that conveys at least one of the first intent and the second intent, a textual message that conveys at least one of the first intent and the second intent with or without the gesture, an audio message that conveys at least one of the first intent and the second intent with or without the gesture, and an animated message that conveys at least one of the first intent and the second intent with or without the gesture, wherein the message is transmitted to a receiving user via a computing device over a communication medium.

Example 8 includes the subject matter of Example 1, wherein the detection/reception logic is further to detect an expression initiated by the sending user having access to the apparatus, wherein the expression is at least one of translated and interpreted to determine a third action based on a third intent relating to the expression, wherein the message is transmitted based on the third action.

Example 9 includes the subject matter of Example 1, wherein the gesture includes a physical gesture caused by a movement of at least one of one or more physical body parts and one or more physical objects, wherein the expression includes a bodily movement causing a facial expression including one or more of smiling, frowning, raising of eyebrows, rolling of eyes, opening or closing of the eyes, showing of teeth, wrinkling of a forehead, and changing of facial color.

Some embodiments pertain to Example 10 that includes a method for facilitating dynamic and intelligent geographical interpretation of human expressions and gestures, comprising: detecting a gesture initiated by a sending user having access to a computing device; determining a geographic location of the computing device; accessing a translation table having one or more translations of one or more gestures based on one or more geographic locations, wherein accessing further includes choosing a translation corresponding to the gesture; interpreting a first intent associated with the gesture based on the translation; and triggering a first action based on the first intent.

Example 11 includes the subject matter of Example 10, further comprising collecting user preferences relating to at least one of the sending user and the receiving user, wherein the user preferences include user-preferred criteria regarding at least one of translation of the gesture, interpretation of the gesture, and transmission of the gesture.

Example 12 includes the subject matter of Example 11, wherein collecting further comprises generating at least one of a first user profile relating to the sending user and a second user profile relating to the receiving user, wherein the first and second user profiles are generated based on the user preferences.

Example 13 includes the subject matter of Example 11 or 12, wherein the first and second user profiles comprise identifying data relating to the first and second users, respectively, wherein the identifying data includes one or more of names, citizenships, nationalities, ethnicities, mother tongues, language skills, accents, physical appearances, and historical acts.

Example 14 includes the subject matter of Example 10, further comprising obtaining reference content from at least one of the user preferences, the first user profile, and the second user profile.

Example 15 includes the subject matter of Example 10 or 14, further comprising interpreting a second intent associated with the gesture based on the translation and the reference content, and triggering a second action based on the second intent.

Example 16 includes the subject matter of Example 10, further comprising transmitting a message based on at least one of the first action and the second action, wherein the message includes at least one of the gesture, an equivalent gesture that conveys at least one of the first intent and the second intent, a textual message that conveys at least one of the first intent and the second intent with or without the gesture, an audio message that conveys at least one of the first intent and the second intent with or without the gesture, and an animated message that conveys at least one of the first intent and the second intent with or without the gesture, wherein the message is transmitted to a receiving user via a computing device over a communication medium.

Example 17 includes the subject matter of Example 10, further comprising detecting an expression initiated by the sending user having access to the apparatus, wherein the expression is at least one of translated and interpreted to determine a third action based on a third intent relating to the expression, wherein the message is transmitted based on the third action.

Example 18 includes the subject matter of Example 10, wherein the gesture includes a physical gesture caused by a movement of at least one of one or more physical body parts and one or more physical objects, wherein the expression includes a bodily movement causing a facial expression including one or more of smiling, frowning, raising of eyebrows, rolling of eyes, opening or closing of the eyes, showing of teeth, wrinkling of a forehead, and changing of facial color.

Some embodiments pertain to Example 19 includes a system comprising a storage device having instructions, and a processor to execute the instructions to facilitate a mechanism to: detect a gesture initiated by a sending user having access to a computing device; determine a geographic location of the computing device; access a translation table having one or more translations of one or more gestures based on one or more geographic locations, wherein accessing further includes choosing a translation corresponding to the gesture; interpret a first intent associated with the gesture based on the translation; and trigger a first action based on the first intent.

Example 20 includes the subject matter of Example 19, wherein the mechanism is further to collect user preferences relating to at least one of the sending user and the receiving user, wherein the user preferences include user-preferred criteria regarding at least one of translation of the gesture, interpretation of the gesture, and transmission of the gesture.

Example 21 includes the subject matter of Example 19, wherein the mechanism is further to generate at least one of a first user profile relating to the sending user and a second user profile relating to the receiving user, wherein the first and second user profiles are generated based on the user preferences.

Example 22 includes the subject matter of Example 20 or 21, wherein the first and second user profiles comprise identifying data relating to the first and second users, respectively, wherein the identifying data includes one or more of names, citizenships, nationalities, ethnicities, mother tongues, language skills, accents, physical appearances, and historical acts.

Example 23 includes the subject matter of Example 19, wherein the mechanism is further to obtain reference content from at least one of the user preferences, the first user profile, and the second user profile.

Example 24 includes the subject matter of Example 19 or 23, wherein the mechanism is further to interpret a second intent associated with the gesture based on the translation and the reference content, and triggering a second action based on the second intent.

Example 25 includes the subject matter of Example 19, wherein the mechanism is further to transmit a message based on at least one of the first action and the second action, wherein the message includes at least one of the gesture, an equivalent gesture that conveys at least one of the first intent and the second intent, a textual message that conveys at least one of the first intent and the second intent with or without the gesture, an audio message that conveys at least one of the first intent and the second intent with or without the gesture, and an animated message that conveys at least one of the first intent and the second intent with or without the gesture, wherein the message is transmitted to a receiving user via a computing device over a communication medium.

Example 26 includes the subject matter of Example 19, wherein the mechanism is further to detect an expression initiated by the sending user having access to the apparatus, wherein the expression is at least one of translated and interpreted to determine a third action based on a third intent relating to the expression, wherein the message is transmitted based on the third action.

Example 27 includes the subject matter of Example 19, wherein the gesture includes a physical gesture caused by a movement of at least one of one or more physical body parts and one or more physical objects, wherein the expression includes a bodily movement causing a facial expression including one or more of smiling, frowning, raising of eyebrows, rolling of eyes, opening or closing of the eyes, showing of teeth, wrinkling of a forehead, and changing of facial color.

Some embodiments pertain to Example 28 includes an apparatus comprising: means for detecting a gesture initiated by a sending user having access to a computing device; means for determining a geographic location of the computing device; means for accessing a translation table having one or more translations of one or more gestures based on one or more geographic locations, wherein accessing further includes choosing a translation corresponding to the gesture; means for interpreting a first intent associated with the gesture based on the translation; and means for triggering a first action based on the first intent.

Example 29 includes the subject matter of Example 28, further comprising means for collecting user preferences relating to at least one of the sending user and the receiving user, wherein the user preferences include user-preferred criteria regarding at least one of translation of the gesture, interpretation of the gesture, and transmission of the gesture.

Example 30 includes the subject matter of Example 28, wherein the means for collecting further comprises means for generating at least one of a first user profile relating to the sending user and a second user profile relating to the receiving user, wherein the first and second user profiles are generated based on the user preferences.

Example 31 includes the subject matter of Example 29 or 30, wherein the first and second user profiles comprise identifying data relating to the first and second users, respectively, wherein the identifying data includes one or more of names, citizenships, nationalities, ethnicities, mother tongues, language skills, accents, physical appearances, and historical acts.

Example 32 includes the subject matter of Example 28, further comprising means for obtaining reference content from at least one of the user preferences, the first user profile, and the second user profile.

Example 33 includes the subject matter of Example 28 or 32, further comprising means for interpreting a second intent associated with the gesture based on the translation and the reference content, and means for triggering a second action based on the second intent.

Example 34 includes the subject matter of Example 28, further comprising means for transmitting a message based on at least one of the first action and the second action, wherein the message includes at least one of the gesture, an equivalent gesture that conveys at least one of the first intent and the second intent, a textual message that conveys at least one of the first intent and the second intent with or without the gesture, an audio message that conveys at least one of the first intent and the second intent with or without the gesture, and an animated message that conveys at least one of the first intent and the second intent with or without the gesture, wherein the message is transmitted to a receiving user via a computing device over a communication medium.

Example 35 includes the subject matter of Example 28, further comprising means for detecting an expression initiated by the sending user having access to the apparatus, wherein the expression is at least one of translated and interpreted to determine a third action based on a third intent relating to the expression, wherein the message is transmitted based on the third action.

Example 36 includes the subject matter of Example 28, wherein the gesture includes a physical gesture caused by a movement of at least one of one or more physical body parts and one or more physical objects, wherein the expression includes a bodily movement causing a facial expression including one or more of smiling, frowning, raising of eyebrows, rolling of eyes, opening or closing of the eyes, showing of teeth, wrinkling of a forehead, and changing of facial color.

Example 37 includes at least one non-transitory or tangible machine-readable medium comprising a plurality of instructions, when executed on a computing device, to implement or perform a method as claimed in any of claims or examples 10-18.

Example 38 includes at least one machine-readable medium comprising a plurality of instructions, when executed on a computing device, to implement or perform a method as claimed in any of claims or examples 10-18.

Example 39 includes a system comprising a mechanism to implement or perform a method as claimed in any of claims or examples 10-18.

Example 40 includes an apparatus comprising means for performing a method as claimed in any of claims or examples 10-18.

Example 41 includes a computing device arranged to implement or perform a method as claimed in any of claims or examples 10-18.

Example 42 includes a communications device arranged to implement or perform a method as claimed in any of claims or examples 10-18.

Example 43 includes at least one machine-readable medium comprising a plurality of instructions, when executed on a computing device, to implement or perform a method or realize an apparatus as claimed in any preceding claims or examples.

Example 44 includes at least one non-transitory or tangible machine-readable medium comprising a plurality of instructions, when executed on a computing device, to implement or perform a method or realize an apparatus as claimed in any preceding claims or examples.

Example 45 includes a system comprising a mechanism to implement or perform a method or realize an apparatus as claimed in any preceding claims or examples.

Example 46 includes an apparatus comprising means to perform a method as claimed in any preceding claims or examples.

Example 47 includes a computing device arranged to implement or perform a method or realize an apparatus as claimed in any preceding claims or examples.

Example 48 includes a communications device arranged to implement or perform a method or realize an apparatus as claimed in any preceding claims or examples.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
detection/reception logic to detect a gesture initiated by a sending user having access to the apparatus;
geographical identification logic to determine a geographic location of the apparatus;
reference and translation logic to access a translation table having one or more translations of one or more gestures based on one or more geographic locations, wherein the reference and translation logic is further to choose a translation corresponding to the gesture;
interpretation logic to interpret a first intent associated with the gesture based on the translation; and
application/execution logic to trigger a first action based on the first intent.

2. The apparatus of claim 1, further comprising preferences and profile logic to collect user preferences relating to at least one of the sending user and the receiving user, wherein the user preferences include user-preferred criteria regarding at least one of translation of the gesture, interpretation of the gesture, and transmission of the gesture.

3. The apparatus of claim 2, wherein the preferences and profile logic is further to generate at least one of a first user profile relating to the sending user and a second user profile relating to the receiving user, wherein the first and second user profiles are generated based on the user preferences.

4. The apparatus of claim 2, wherein the first and second user profiles comprise identifying data relating to the first and second users, respectively, wherein the identifying data includes one or more of names, citizenships, nationalities, ethnicities, mother tongues, language skills, accents, physical appearances, and historical acts.

5. The apparatus of claim 1, wherein the reference and translation logic is further to access the preferences and profile logic to obtain reference content from at least one of the user preferences, the first user profile, and the second user profile.

6. The apparatus of claim 5, wherein the interpretation logic is further to interpret a second intent associated with the gesture based on the translation and the reference content, and wherein the application/execution logic is further to trigger a second action based on the second intent.

7. The apparatus of claim 1, further comprising communication/compatibility logic to transmit a message based on at least one of the first action and the second action, wherein the message includes at least one of the gesture, an equivalent gesture that conveys at least one of the first intent and the second intent, a textual message that conveys at least one of the first intent and the second intent with or without the gesture, an audio message that conveys at least one of the first intent and the second intent with or without the gesture, and an animated message that conveys at least one of the first intent and the second intent with or without the gesture, wherein the message is transmitted to a receiving user via a computing device over a communication medium.

8. The apparatus of claim 1, wherein the detection/reception logic is further to detect an expression initiated by the sending user having access to the apparatus, wherein the expression is at least one of translated and interpreted to determine a third action based on a third intent relating to the expression, wherein the message is transmitted based on the third action.

9. The apparatus of claim 1, wherein the gesture includes a physical gesture caused by a movement of at least one of one or more physical body parts and one or more physical objects, wherein the expression includes a bodily movement causing a facial expression including one or more of smiling, frowning, raising of eyebrows, rolling of eyes, opening or closing of the eyes, showing of teeth, wrinkling of a forehead, and changing of facial color.

10. A method comprising:
detecting a gesture initiated by a sending user having access to a computing device;
determining a geographic location of the computing device;
accessing a translation table having one or more translations of one or more gestures based on one or more geographic locations, wherein accessing further includes choosing a translation corresponding to the gesture;
interpreting a first intent associated with the gesture based on the translation; and
triggering a first action based on the first intent.

11. The method of claim 10, further comprising collecting user preferences relating to at least one of the sending user and the receiving user, wherein the user preferences include user-preferred criteria regarding at least one of translation of the gesture, interpretation of the gesture, and transmission of the gesture.

12. The method of claim 11, wherein collecting further comprises generating at least one of a first user profile relating to the sending user and a second user profile relating to the receiving user, wherein the first and second user profiles are generated based on the user preferences.

13. The method of claim 11, wherein the first and second user profiles comprise identifying data relating to the first and second users, respectively, wherein the identifying data includes one or more of names, citizenships, nationalities, ethnicities, mother tongues, language skills, accents, physical appearances, and historical acts.

14. The method of claim 10, further comprising obtaining reference content from at least one of the user preferences, the first user profile, and the second user profile.

15. The method of claim 14, further comprising interpreting a second intent associated with the gesture based on the translation and the reference content, and triggering a second action based on the second intent.

16. The method of claim 10, further comprising transmitting a message based on at least one of the first action and the second action, wherein the message includes at least one of the gesture, an equivalent gesture that conveys at least one of the first intent and the second intent, a textual message that conveys at least one of the first intent and the second intent with or without the gesture, an audio message that conveys at least one of the first intent and the second intent with or without the gesture, and an animated message that conveys at least one of the first intent and the second intent with or without the gesture, wherein the message is transmitted to a receiving user via a computing device over a communication medium.

17. The method of claim 10, further comprising detecting an expression initiated by the sending user having access to the apparatus, wherein the expression is at least one of translated and interpreted to determine a third action based on a third intent relating to the expression, wherein the message is transmitted based on the third action.

18. The method of claim 10, wherein the gesture includes a physical gesture caused by a movement of at least one of one or more physical body parts and one or more physical objects, wherein the expression includes a bodily movement causing a facial expression including one or more of smiling, frowning, raising of eyebrows, rolling of eyes, opening or closing of the eyes, showing of teeth, wrinkling of a forehead, and changing of facial color.

19. At least one machine-readable medium comprising a plurality of instructions, executed on a computing device, to facilitate the computing device to:
detect a gesture initiated by a sending user having access to a computing device;
determine a geographic location of the computing device;
access a translation table having one or more translations of one or more gestures based on one or more geographic locations, wherein accessing further includes choosing a translation corresponding to the gesture;
interpret a first intent associated with the gesture based on the translation; and
trigger a first action based on the first intent.

20. The machine-readable medium of claim 19, wherein the computing device is further to collect user preferences relating to at least one of the sending user and the receiving user, wherein the user preferences include user-preferred criteria regarding at least one of translation of the gesture, interpretation of the gesture, and transmission of the gesture,
wherein the computing device is further to generate at least one of a first user profile relating to the sending user and a second user profile relating to the receiving user, wherein the first and second user profiles are generated based on the user preferences, wherein the first and second user profiles comprise identifying data relating to the first and second users, respectively, wherein the identifying data includes one or more of names, citizenships, nationalities, ethnicities, mother tongues, language skills, accents, physical appearances, and historical acts.

21. The machine-readable medium of claim 19, wherein the computing device is further to obtain reference content from at least one of the user preferences, the first user profile, and the second user profile.

22. The machine-readable medium of claim 21, wherein the computing device is further to interpret a second intent associated with the gesture based on the translation and the reference content, and trigger a second action based on the second intent.

23. The machine-readable medium of claim 19, wherein the computing device is further to transmit a message based on at least one of the first action and the second action, wherein the message includes at least one of the gesture, an equivalent gesture that conveys at least one of the first intent and the second intent, a textual message that conveys at least one of the first intent and the second intent with or without the gesture, an audio message that conveys at least one of the first intent and the second intent with or without the gesture, and an animated message that conveys at least one of the first intent and the second intent with or without the gesture, wherein the message is transmitted to a receiving user via a computing device over a communication medium.

24. The machine-readable medium of claim 19, wherein the computing device is further to detect an expression initiated by the sending user having access to the apparatus, wherein the expression is at least one of translated and interpreted to determine a third action based on a third intent relating to the expression, wherein the message is transmitted based on the third action.

25. The machine-readable medium of claim 19, wherein the gesture includes a physical gesture caused by a movement of at least one of one or more physical body parts and one or more physical objects, wherein the expression includes a bodily movement causing a facial expression including one or more of smiling, frowning, raising of eyebrows, rolling of eyes, opening or closing of the eyes, showing of teeth, wrinkling of a forehead, and changing of facial color.
